(19) United States
(12) Patent Application Publication
(10) Pub. No.: US 2024/0060261 A1
(43) Pub. Date: Feb. 22, 2024

(54) SEDIMENT TRAPS AND SKY MOISTURE ACCUMULATING AND DISSIPATING INDUCING TECHNOLOGY

(71) Applicant: Just-Jeff, Salcha, AK (US)

(72) Inventor: Just-Jeff, Salcha, AK (US)

(21) Appl. No.: 17/890,723

(22) Filed: Aug. 18, 2022

(51) Int. Cl. E02B 3/02

(52) U.S. Cl. CPC E02B 3/023

(57) ABSTRACT

A mining method from the use of a Sediment Trap. And a set of Sediment Traps of Different design that by their usage cause an inducement; in the atmosphere of the natural Environment and the hydrosphere of the natural Environment and a part of the lithosphere connected to the hydrosphere of the natural Environment.

### BRIEF DESCRIPTION OF THE DRAWINGS

FIG. 1 is a Top view of a round Cable Mounted Sediment Trap 1 with part of the center protective sleeve removed to view cable inside;

FIG. 2 is a side view of a round Cable Mounted Sediment Trap 1 also with an inside ghost view showing the mounting plates holding the magnets and the washers with the bolt and side view of protective sleeve around cable;

FIG. 3 is an elevation view of a round Cable Mounted Sediment Trap 1 showing the welded mounting plates and the open areas around them for water to flow freely inside the outer steel hull;

FIG. 4 is an elevation view of a Pole Mounted Underwater Sediment Trap 16 with upturned sides with a large sheet metal base similar to a foot for mounting the magnets and a side strength stiffener from one side to the pole for safely placing in and lifting out of a waterway;

FIG. 5 is a side view of the Pole for the Pole Mounted Underwater Sediment Trap 16, and it shows a ghost view of the solid inner sleeve for bolting together the compartmental Pole and support brace and at the end a welded-on ring;

FIG. 6 is another elevation view of Pole Mounted Underwater Sediment Trap 16 with a new hinge pole mount and a Foot toes design on end for better water flow;

FIG. 7 is a magnified cable end view of Cable Mounted Sediment Trap 16 with the cable clamp removed for closer detail and a ghost view of the inside plates, magnets and washers;

FIG. 8 is an application scene of a dangerous river canyon or fast moving waterway and the usage of the Floating Sediment Trap 39 shown as number 39;

FIG. 9 is a magnified side view39 and top view 39T of the Floating Sediment Trap 39 with fins and with Strong tether line and tangle free cup for magnet holding and sediment capture from a river bottom;

FIG. 10 is an application scene of the various areas of usage on the planet of the Heavy Block Sediment Trap 21 seen as number 21;

FIG. 11 is a magnified elevation view of the Heavy Block Sediment Trap 21;

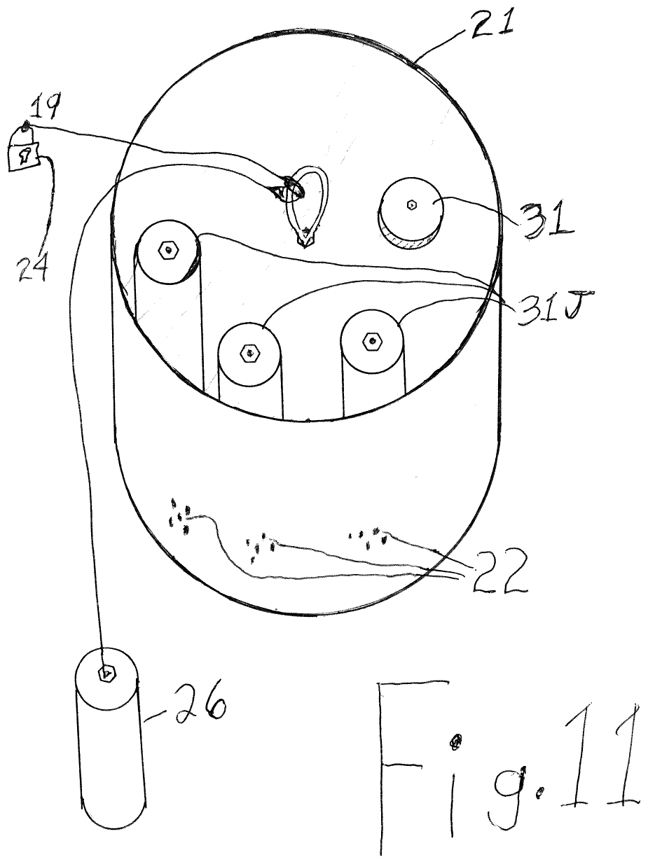

FIGS. 8 and 10 also show that the Removal of and the placement of or buildup of Magnetic sand can effect the Sky 30 as one cloud in Sky 30 has water under it and the other does not.

FIG. 12 is a photocopy of a photograph of a side view of a design of a Sediment Trap tested in July 2022 it was found to wear excessively on the cable so a cable sleeve addition is needed and not shown and it worked very good for picking up magnetic sediment.

Invention Explanation of Specifications is as Follows;

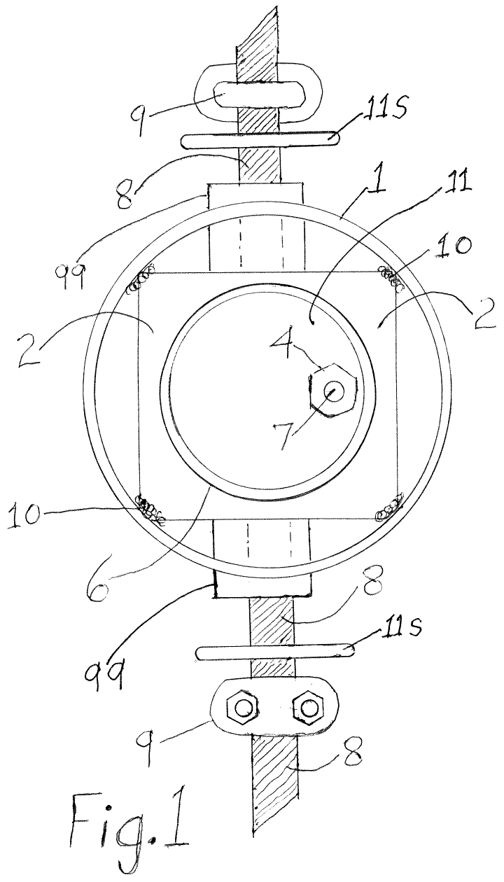

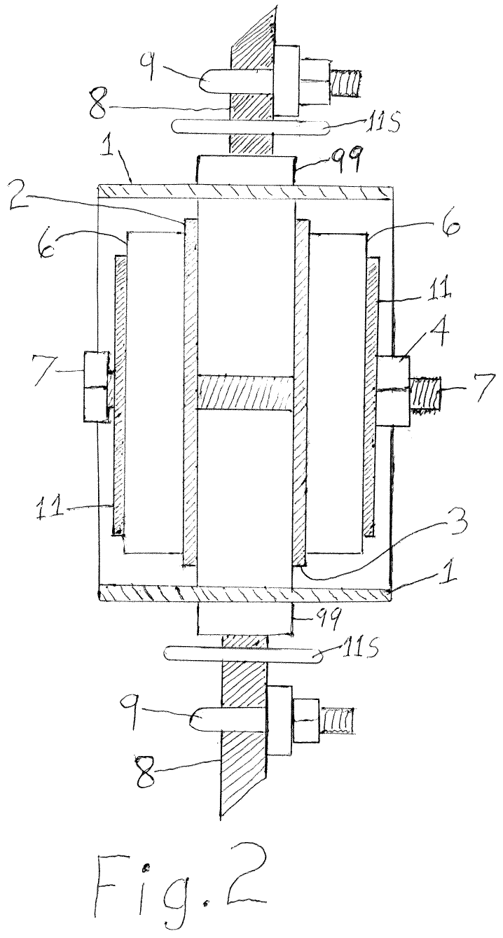

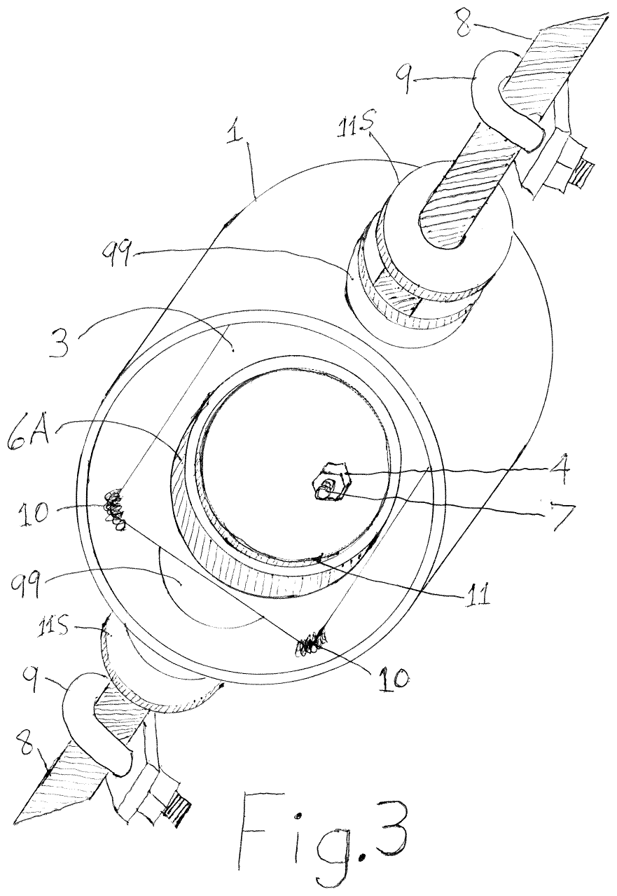

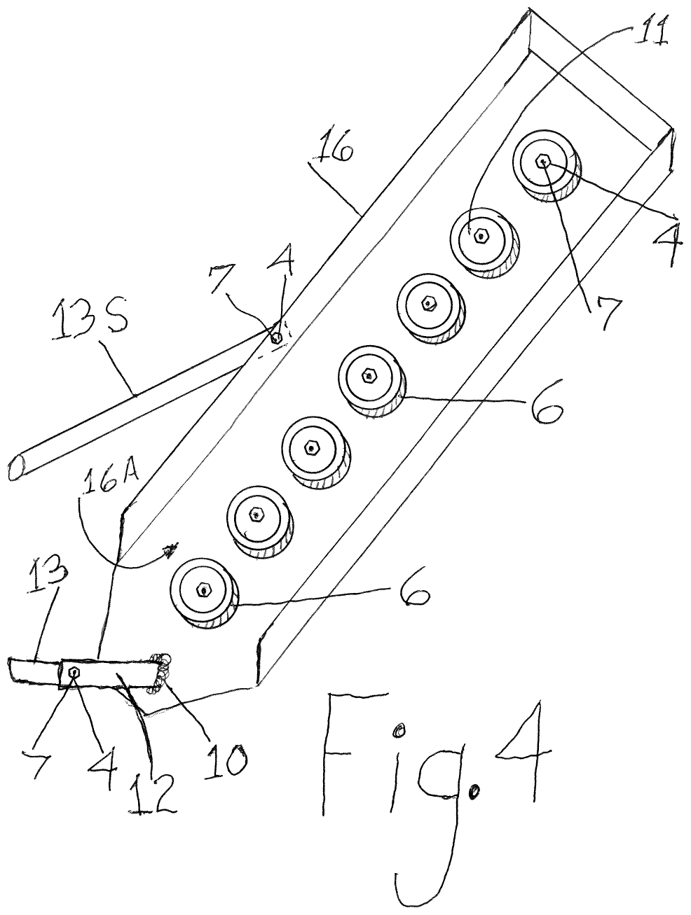

First is a; Cable Mounted Sediment Trap 1 Device shown in FIGS. 1,2,3 and 7 of Figures pages, with an outer round Steel shell 1 with a steel cable8 that runs through a hole in the center and is fastened with cable clamps 9 and held in place by one metal plate on top 2 of and one plate 3 under cable 8 and both plates welded 10 in place with openings on all four sides to allow sediment to flow freely through it but yet protect the two magnets6 held in place by bolt 7 and nut 4 and washers 11. In FIG. 7 the Sleeve 99 is for protecting cable8 from wear is shown with protective washers 11S for sleeve 99 ends for protection from cable clamps9. This design also allows maximum water flowage around the magnets for maximum magnetic sediment pull when used under water and yet safety on rocks so getting caught the Sediment Trap 1 can slide around it and spin 360 degrees. this design was tested and worked excellent. Sediment Trap 1 can also be mounted one after another with cable clamps9 on cable 8 on long cable8 like hundreds and hundreds of feet in length. Note: in FIG. 3 magnet 6A shown smaller just for Illustration purpose only.

Second is a; Pole Mounted Underwater Sediment Trap 16 Device shown in FIGS. 4, 5 and 6 of Figures pages, with a steel plate base16 of heavy sheet metal for strength in the shape of a long rectangle of about yardstick length with upturned edges for strength which gives the best pull for surface area and still is small enough to be handled with pole 13 of which it is compartment able with insert15 with bolts 7 and nuts 4 for shipping and transport and ring14 for mounting to the shoreline of a river or silt laden waterway with rope or cable and bolted7 and nutted4 to welded 10 mount 12 of the basel6 and it also has a web stiffener 13S of which is also mounted from pole 13 to basel6 by bolt 7 and nut 4 for ease of placement and for trees and rocks areas to lift and pry it out safely and not get stuck And the center of base 16 is lined with magnets6 mounted with bolts 7 and washers 11 and nuts 4. this Sediment Trap device design was tested and is clumsy but works well. In addition to the present Trap 16 design on FIG. 4 of Figures pages is an additional innovative design of the Pole Mounted Underwater Sediment Trap 16 on FIG. 6 of Figures pages with a new Bigfoot17 Toe design17 for increased water flowage through trap 16 which causes more magnetic sediment absorption from magnets6 in the surrounding waters sediment trap 16 is placed in and it16 also has a new hinged18 mounted pole 13 with a welded 10 base for ease of transport and storage as pole 13 can be easily folded up onto Sediment trap 16.

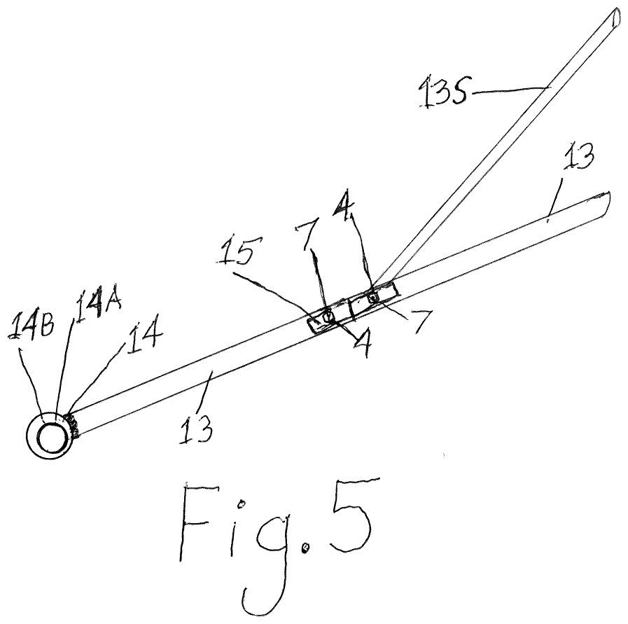

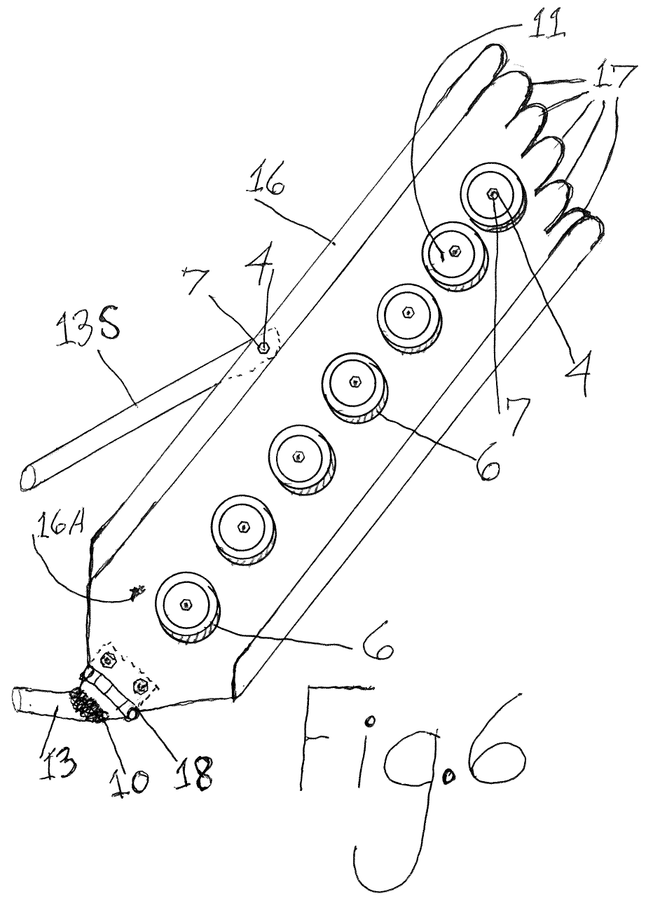

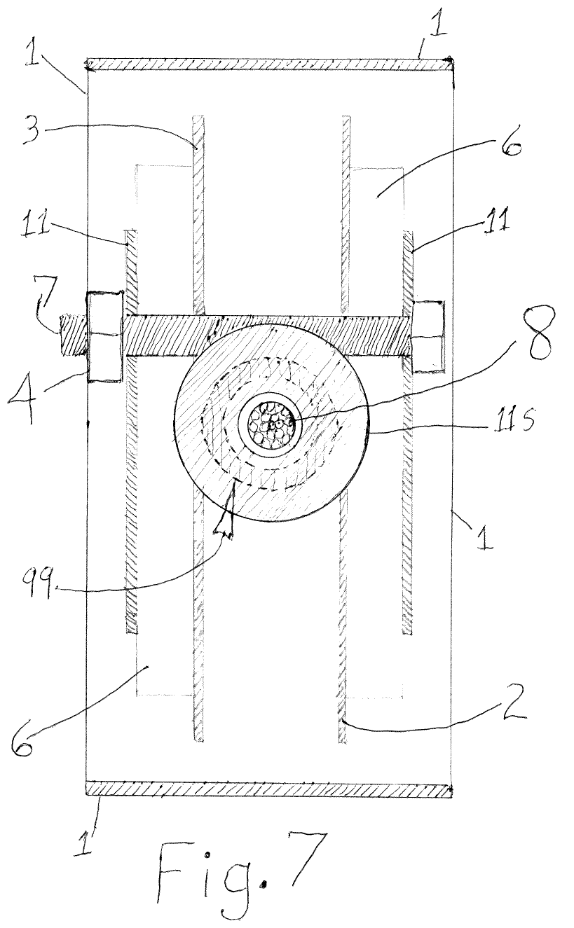

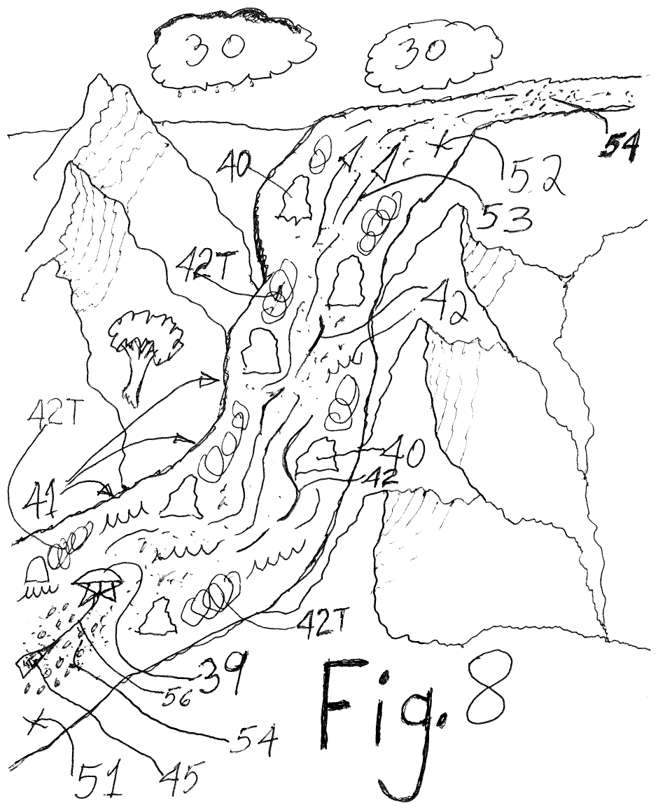

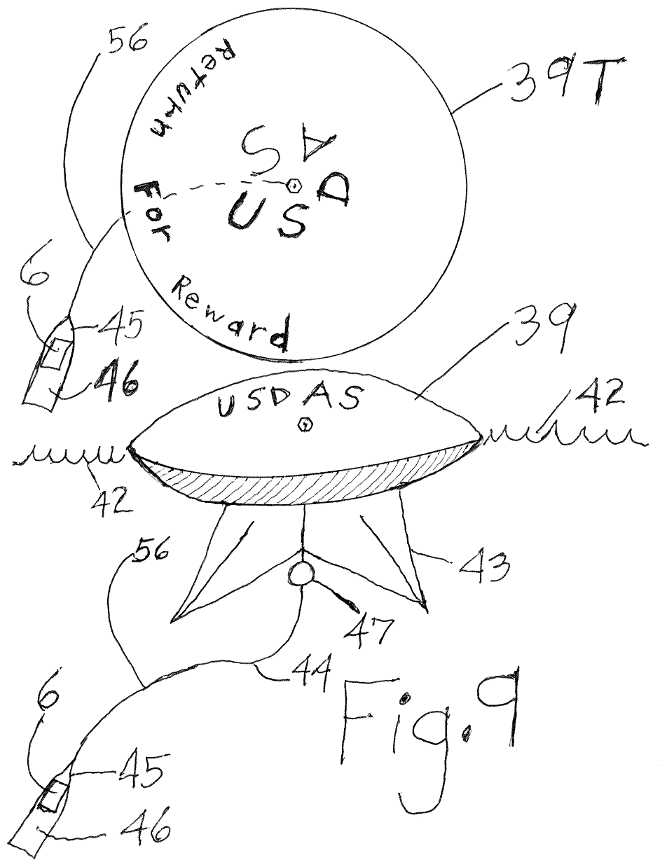

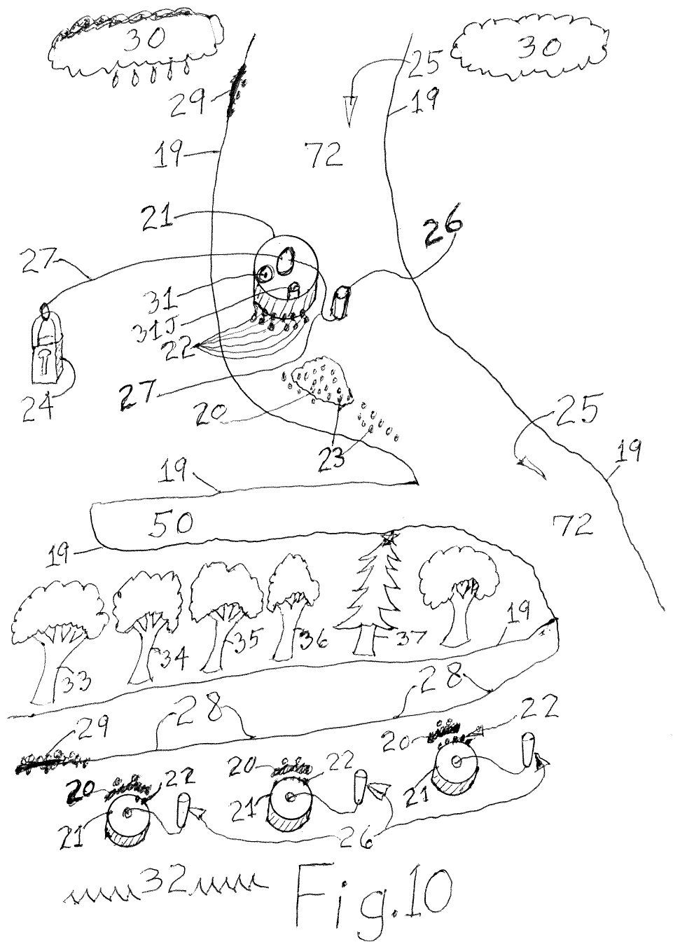

Third is a; Floating Sediment Trap 39 Device with specifications shown in FIGS. 8 and 9 of Figures Pages and is a Floating Sediment Trap 39 of which It 39 is of a round design like a disc shaped buoy 26 similar to a large football in which it also has fins 43 that catch on the water current flow 53 for use in areas of Dangerous Canyons 41 and It 39 also has a strong tether line 44 of steel cable 56 with a smooth hollow 46 Cone 45 on the end of the line 44 with a magnet6 inside for absorbing so magnetic sediment 54 from such dangerous river areas filled with rocks40 and rapids and yet cone 45 is smooth enough so as to slip through the area hopefully without getting snagged. Floating Sediment Trap 39 would be placed in a river at area 51 and picked up downstream at a safe area such as area 52 through the pulling action 42 and turbulent action 42T of the water flow 53 on fins 43 while picking up sediment 54 from the bottom of the waterway as it floats along. This usage of Floating Sediment Trap 39 besides mining black sand would also be used for sediment 54 collection and removal from any current53 flow 53 waterway in order to Induce Sky 30 Moisture in areas around such usage. Also in FIG. 9 is an enlarged version of Floating Sediment Trap 39 with a loop47 attachment on the bottom for the strong tether line 44 of steel cable 56 and smooth hollow 46 Cone 45 with magnet6 inside for absorbing magnetic sediment 54 on end of tether line 44 as it slides across the bottom of a waterway and the view of 39T is only a top view of Floating Sediment Trap 39 with hollow 46 cone 45 and strong tether line 44 and magnet6 with an example business lettering on top for returning if lost in like Dangerous Canyon41 or area 51 to 52.

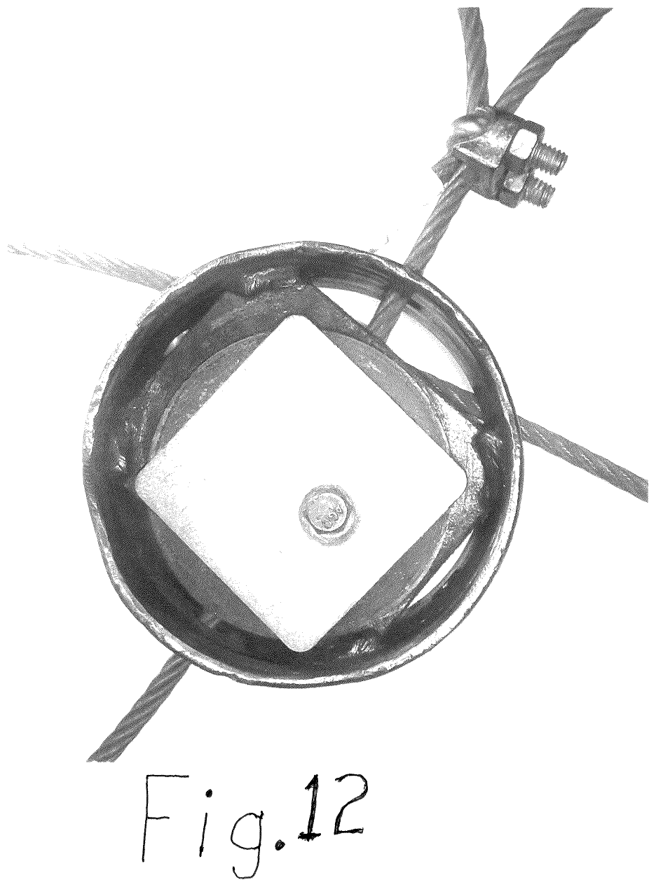

The fourth is a Heavy Block Sediment Trap 21 with Specifications shown in Figure 10 and 11 of Figures Pages and is a powerful tool, because it is larger, for in the Methods of Sky 30 Moisture Accumulating And Dissipating Inducing Control and also Waterway Erosion 29 and Sedimentation 20 Control Inducing with Heavy Block Sediment Traps 21 that are a magnet or magnetic or have magnets 31 fastened to them or that have magnets 31J inside of them like a large concrete block version for economical cost, and are placed and used underwater in lakes streams rivers 72 reservoirs or Harbors 50 or by any Beach 28 or Coastline and in which the current flow 25 or Ocean wave action32 of the water of those same lakes streams rivers 72 reservoirs or Harbors 50 or by any Beach 28 will not budge them 21 and they 21 can be used for magnetic sediment 22 removal to Induce moisture accumulation in the sky 30 or also to build up magnetic sediment 22 on them 21 to make the sky 30 Dissipate moisture and also can be tethered 27 by chain 27 or cable 27 to a buoy 26 and or to the shoreline 19 with a lock 24 for safety and security and easy removal by lifting out and replacement again. In a similar manner those same Heavy Block sediment traps 21 that are a magnet or magnetic or have magnets 31 fastened to them or have magnets 31J inside of them 21 can be used for Erosion 29 or Sedimentation Control, by first removing magnetic sediment 22 continually from the river 72 channel or Harbor 50 with the Heavy Block sediment traps 21 by vacuum dredging it 22 off them 21 or also by lifting them 21 out and in again and removing magnetic sediment 22 from the Heavy Block sediment traps 21 continually for keeping a River 72 or Harbor 50 channel open. Then those same Magnetic Heavy Block sediment traps 21 can also be used for Filling in an area 20 on a River 72 with river grave 123 and or sediment 23 that is having River bank erosion 29 problems by magnetic Inducing sedimentation in areas 20 by leaving those Heavy Block Sediment Traps 21 in the river 72 for very long periods of time to build up massive magnetic sediment 22 on them 21 by magnetic absorption from the water moving the magnetic sediment which in turn will magnetically Induce river 72 sedimentation 23 in areas 20 near them 21 in the river 72 and Those same Heavy Block sediment traps 21 can be tethered 27 with a chain 27 or cable 27 to a buoy 26 for safety and or tethered 27 to the shoreline 19 securely with a lock 24. The row of trees listed are Birch 33, Oak 34, Aspen 35, Tamarack 36 and Spruce 37 and an unknown tree along the Beach 28 are seen to symbolize that this Sky 30 Moisture Accumulating And Dissipating Inducing Technology and Erosion 29 and Sedimentation 23 Control Inducing Technology both together a.k.a. Environmental Magnetic Inducing Technology can be used anywhere on Planet earth. It is also a fact that Cottonwood are mineral containing woods and when washed in rotted and dissolved in rivers actually deposit low levels of iron sediment as a Dead Cottonwood tree I have witnessed registered a mineral reading on a Highly sensitive Handheld Gold Metal Detector. Mineral streaks can be found in lumber from many tree species is also a fact. The Heavy Block Sediment Traps 21 can also be placed near Beaches 28 for the same Erosion 29 control by containing the magnetic sand 22 by magnetic absorption to build up massive sedimentation in area 20 along the Beach 28 shoreline by magnetic Inducing of surrounding magnetic sediment and this too after time through sky 30 Inducing will also Dissipate clouds and moisture in the Sky 30 above from the area around them 21 and miles of them spaced a quarter mile apart placed along an Ocean shoreline could Possibly detour Hurricanes or at least lessen shoreline erosion severity.

The explanation of Environmental Magnetic Inducing Technology can be explained from two parts being part one as Sky Moisture Accumulating And Dissipating Inducing Technology and part two as Erosion And Sedimentation Control Inducing Technology and both parts can be done with all of the Sediment Traps in this Patent application and the Technology application is lightly shown in FIGS. 8 and 10 of the Figures Pages and its entirety is explained here simply as when a piece of Heavy Equipment is used to dig a ditch the ground eventually wants to cave in or similarly a Pile of Gravel eventually erodes down the sides of the pile. This is the same way this technology works as in the Sky it wants to fall into the ditch so to speak where You pull the magnetic sediment out of a river or moving waterway from what I understand the Sky is induced to move into an area with ions to fill the gap and this causes clouds and moisture to form and eventually Rain the severity of associated with the removal of the magnetic sand. By the opposite You can cause an area to Dissipate Sky moisture by dumping heavy deposits of Iron or Magnetic sand into a waterway over a few feet to hundreds of miles and cause eventually a drought of the severest kind. The Erosion and Sedimentation are also involved as they are both intricately interlocked as one Technology for Erosion Control You would simply place Heavy magnets in a waterway the current could not budge and sure enough sediment and rocks and sand will build up in that waterway around or near them and by the opposite effect You can remove sediment from a waterway with Magnets by dragging the channel of the waterway to remove magnetic sediment and the waterway will collapse as if You fired up a dredge or a dragline crane I have witnessed this with my own eyes and it does not happen overnight but over weeks and months to years. This Erosion and Sedimentation Control—part of the Lithosphere, also effects the Sky-part of the atmosphere, so both parts are locked together as; Environmental Magnetic Inducing Technology. I would like to divest more but I am sure You have enough knowledge explained clear enough here as it has taken me 16 years of journey to discover this and anymore, I wish to reserve to my personage.

1. Sediment Trap 1 with magnet (6) mounted on for collecting sediment

2. Sediment Trap 1 connected by a steel Cable (8)

3. Sediment Trap 1 that is Rotatable in a circle on the cable (8)

4. Sediment Trap 1 has a sleeve (99) to protect cable (8) when cable (8) spins inside hole through shell (1)

5. Sediment Trap 1 also has a set of washers on each end of sleeve (99) for protection from cable clamps (9)

6. Sediment Trap 1 held in place on cable (8) by cable clamps (9)

7. Sediment Trap 1 can be hooked up in great numbers together with cable (8) in great cable (8) lengths for massive sediment removal

8. Sediment Trap 1 is environmentally friendly

9. Sediment Trap 1 with a Round circular steel safety shell (1)

10. Sediment Trap 1 with welded in place inner plates (2) and (3) for mounting magnet (6)

11. Sediment Trap 1 with a bolt (7) and nut (4) and washers (11) for securing magnets on plates (2) and (3)

12. Sediment Trap 1 after full of sediment can be washed off easily with pressurized water

13. Sediment Trap 1 can also be used underwater in lakes streams waterways rivers and reservoirs

14. Sediment Trap 16 with magnets (6) mounted on for collecting sediment

15. Sediment Trap 16 with bolts (7) nuts (4) and washers (11) for securing Sediment Traps parts together

16. Sediment Trap 16 is for sediment collecting use underwater only in lakes streams waterways rivers and reservoirs

17. Sediment Trap 16 with a heavy gauge sheet metal base (16A)

18. Sediment Trap 16 that has bent upward edges on sheet metal base (16A) for strength and to better retain magnetic sediment

19. Sediment Trap 16 with a connector (15) for holding pole (13) together

20. Sediment Trap 16 is environmentally friendly

21. Sediment Trap 16 with a web stiffener (13S) from the base (16A) to pole (13)

22. Sediment Trap 16 with a pole (13) that can be detached from welded base for transport

23. Sediment Trap 16 that has a welded base (12) for removeable pole 13

24. Sediment Trap 16 with a welded ring (14) on pole (13) for securing safely

25. Sediment Trap 16 that can be tethered to the shoreline by Ring (14)

26. an exclusive claim for; Environmental Magnetic Inducing Technology, which includes two parts, Part one being For a complete process patent of Sky Moisture Accumulating and Dissipating Inducing Technology from the applied use of Sediment Traps 1 and 16 and 21 and 39 underwater and also Sediment Trap 1 above water and their simple Sky Moisture Accumulating ionic inducing effect from such usage of magnetic sediment collection and removal from waterways Like streams Harbors lakes rivers and Reservoirs and Oceans and the controlled dispersion of some of that same magnetic sediment back into those same waterways or land for Sky Moisture Dissipating ionic Inducing effect. And Part two being a complete process patent for Erosion and Sedimentation Control Inducing Technology also from the usage of Sediment Traps 1 and 16 and 21 and 39 through the collection and removal of magnetic sediment from waterways to induce erosion or channel clearing and the opposite effect of sedimention buildup and erosion stopping can be done by the strategic placement of the Sediment Traps 1 and 16 and 21 and 39 in a permanent position in a waterway for magnetic sediment buildup. Both parts one and two stated above in this claim are integral parts of one technology that I claim as originator: Environmental Magnetic Inducing Technology

27. For a patent for a Method of Magnetic Sediment Collection from the use of Sediment Trap 1 in sediment laden waterways such as lakes rivers Streams reservoirs for underwater use by dragging Sediment Trap 1 through those waterways such as lakes rivers Streams and reservoirs deep under the water manually behind a boat or boats or by automated winching equipment pulling Sediment Trap 1 across waterways under the water to the shoreline on each side continually for massive magnetic sediment collection.

28. Sediment Trap 1 that can be made up to Eight feet in Diameter for Ocean use

29. Sediment Trap 16 with a New hinged (18) mount welded to Plate (16A) and Pole (13) for ease of storage and transport

30. Sediment Trap 16 with a curved upward Bigfoot Toe design (17) for better absorbing of underwater magnetic sediment from water flowing more freely over plate (16A)

31. a Heavy Block Sediment Trap 21 that is a magnet

32. a Heavy Block Sediment Trap 21 that is magnetic

33. a Heavy Block Sediment Trap 21 that has magnets (11) fastened to it

34. a Heavy Block Sediment Trap 21 that has magnets inside it

35. a Heavy Block Sediment Trap 21 that is magnetic and is tethered (27) with a Chain (27) to a Buoy (26)

36. a Heavy Block Sediment Trap 21 that is magnetic and is tethered (27) with a chain (27) to a shoreline (19)

37. a Heavy Block Sediment Trap 21 that is magnetic and is tethered (27) with a chain (27) to the shoreline (19) and is secured with a lock (24)

38. a Heavy Block Sediment Trap 21 that is magnetic and is used underwater.

39. Floating Sediment Trap 39 that floats on water of a round disc shape

40. Floating Sediment Trap 39 that floats on water with an attached strong tether line (44) of steel cable (56) that is attached to the bottom

41. Floating Sediment Trap 39 that floats on water with an attached strong tether line (44) of steel cable (56) with a non-snagging smooth hollow (46) cone (45) with a magnet (6) inside on the end of the tether line (44) for collecting magnetic sediment from rivers streams lakes Harbors or channels or any waterway.

42. Floating Sediment Trap 39 that floats on water with attached fins (43) underneath it for catching water movement for propulsion downstream on a river

43. Floating Sediment Trap 39 that floats on water with a remote-controlled motor-powered propulsion source so you can control it like a small remote-controlled boat with an attached strong tether line (44) of steel cable (56) with a non-snagging smooth hollow (46) cone (45) with a magnet (6) inside on the end of the tether line (44) for collecting magnetic sediment, from rivers streams lakes Harbors or channels or any waterway.
